(19) United States
(12) Patent Application Publication
(10) Pub. No.: US 2007/0070972 A1
(43) Pub. Date: Mar. 29, 2007

(54) Recounting method in multimedia broadcast/multicast service

(75) Inventors: Yanhong Wang, Guangdong (CN); Hao Hu, Guangdong (CN)

Correspondence Address: WOOD, PHILLIPS, KATZ, CLARK & MORTIMER, 500 W. MADISON STREET, SUITE 3800, CHICAGO, IL, 60661, US

(73) Assignee: Huawei Technologies Co., Ltd.

(21) Appl. No.: 11/526,491

(22) Filed: Sep. 25, 2006

Related U.S. Application Data
(63) Continuation of application No. PCT/CN05/01632, filed on Sep. 30, 2005.

(30) Foreign Application Priority Data
Sep. 30, 2004 (CN) 200410079356.5

(51) Int. Cl. H04J 3/24; H04L 12/56

(52) U.S. Cl. 370/349; 370/390

(57) ABSTRACT

The present invention discloses a method for recounting the number of the UE in a multimedia broadcast/multicast service. When a radio access network prepares to initiate a recounting procedure, perform the steps of: the RAN sending recounting indication information for an MBMS service to User Equipment (UE) or UEs; the UE detecting the recounting indication information and responding to the recounting indication information by establishing a radio resource control (RRC) connection or initiating a cell update procedure according to the recounting indication information and received MBMS access information; the RAN counting the number of UE(s) which have joined the MBMS service and are within a cell according to the state of the UEs respectively. The application of the present invention will make the recounting result more accurate, thus the selection of MBMS bearer mode by UTRAN based on the recounting result is more appropriate.

### CROSS-REFERENCE TO RELATED APPLICATIONS

This application is a continuation application of International Application No. PCT/CN2005/001632, filed Sep. 30, 2005, which claims priority in Chinese Application No. 2004-10079356.5, filed Sep. 30, 2004, both of which are entitled “Recounting Method in Multimedia Broadcast/Multicast Service”. The full disclosure of these applications are hereby incorporated by reference.

### FIELD OF THE INVENTION

The present invention relates to techniques for implementing Multimedia Broadcast/Multicast Service (MBMS), and more particularly, to a recounting technique in Multimedia Broadcast/Multicast Service.

### BACKGROUND OF THE INVENTION

In a communication system, multicast and broadcast are techniques for transferring data from one source to multiple destinations. For instance, in the Ethernet, the Internet Group Management Protocol (IGMP) is an Internet Protocol (IP) multicast technique for the use of multicast.

With development of mobile communications, multicast and broadcast are applied more and more in mobile networks. For example, in a traditional mobile network, the Cell Broadcast Service (CBS) allows low bit-rate data to be transferred to all users via a shared broadcasting channel of a cell. This service is categorized as a message service.

At present, voice and message services can not satisfy people's requirements for mobile communications. Along with the rapid development of the Internet, a great number of multimedia services emerge. Some application services therein require that multiple users are able to receive same data simultaneously, e.g. video on demand, videocast, video conference, network-based education and interactive video games. These multimedia services are featured with large data flow, long time duration and high sensitivity to time delay in comparison to the conventional data. The existing techniques of the IP multicast make it possible to implement these multimedia services in form of multicast or broadcast on cabled IP networks. However, as mobile networks have special network architecture, functional entities and radio interfaces, which are all different from those of a cabled IP network, existing IP multicast techniques are not applicable to mobile networks.

In order to solve the above problem and make an efficient use of resources of mobile networks, the Wideband Code Division Multiple Access (WCDMA)/Global System for mobile Communication (GSM) and the 3^{rd} Generation Partnership Project 3GPP), have put forward the Multimedia Broadcast/Multicast Service (MBMS), designed to provide services of forwarding data from one source to multiple users in mobile networks so as to share and improve the utility rate of network resources, especially the utility rate of radio interface resources. The MBMS defined by the 3GPP can implement not only multicast and broadcast of low-rate text messages, but also multicast and broadcast of high-rate multimedia traffic, which is no doubt in accordance with the trend of future development of mobile data.

System architecture of MBMS defined by the 3GPP is as shown in FIG. 1, wherein the Broadcast Multicast-Service Center (BM-SC), a newly-added mobile network functional entity supporting MBMS, is the entrance of content providers and is used to authorize, initiate an MBMS bearer service in the mobile networks and transfer MBMS contents according to a predefined time schedule. In addition, functional entities, such as user equipment (UE), a UMTS Terrestrial Radio Access Network (UTRAN), a GSM EDGE Radio Access Network (GERAN), a Serving GPRS Support Node (SGSN) and a GPRS Gateway Support Node (GGSN), are enhanced to incorporate relevant functions of MBMS.

The MBMS is implemented in two modes, the multicast mode and the broadcast mode. As there is difference between the multicast mode and the broadcast mode in service demands, the service procedures thereof are different.

The flowchart of MBMS multicast mode is as shown in FIG. 2.

In the MBMS multicast mode, a user joins an MBMS multicast service by an MBMS activation procedure so that the network could know which user desires to receive some particular MBMS service. The network nodes create, through an MBMS registration procedure, a distribution tree from a BM-SC to a Base Station Controller (BSC)/Radio Network Controller (RNC) via a GGSN and SGSN so as to allow the session attributes and data of MBMS to be transferred. The registration procedure creates an MBMS bearer context at relevant nodes. When the BM-SC is ready for transferring data, an MBMS Session Start procedure will be triggered. The Session Start procedure activates all requested bearer resources for transferring MBMS data in the network and notifies the interested UEs (As used herein and hereafter, the term “UEs” encompasses zero, one or more UEs.) that the data transfer is about to start. By this procedure, the BM-SC provides the interested and relevant network nodes with the session attributes, such as Quality of Service (QoS), MBMS Service Area and parameter of estimated session duration. This procedure also triggers such procedures as session notification, counting of cell users, selection of radio bearer type, set-up of radio and cabled bearer planes on the access network by the RNC. The BM-SC starts transferring multicast data after the down-stream nodes completing corresponding jobs. Each node transfers the multicast data to the UEs through the bearer created in the Session Start procedure.

The service procedure of MBMS broadcast mode is as shown in FIG. 3.

In the MBMS broadcast mode, as information of a broadcast service is sent to all users in the radio network, each network node does not need to implement the MBMS registration procedure. When the BM-SC is ready for transferring data, an MBMS Session Start procedure is triggered which activates all the bearer resources requested by transferring MBMS data in the network. By this procedure, the BM-SC provides the relevant interested network nodes with the session attributes, such as the Terminal Mobile Group Identity (TMGI) of the MBMS bearer service, QoS, MBMS Service Area, and parameter of estimated session duration (if there is). This procedure also triggers such jobs as set-up of radio and cabled bearer planes. The BM-SC starts transferring broadcast data after the down-stream nodes completing corresponding jobs. Each node transfers the broadcast data to the UEs through the bearer created in the Session Start procedure.

It can be seen by persons skilled in the art that the main service procedures of MBMS broadcast mode and multicast mode are similar, both including the process of the successive procedures of Service announcement, Session Start, MBMS notification, Data transfer, and Session Stop. The difference between the two modes lies in that the multicast mode also includes the step for the UE subscribing to the appropriate multicast group, activating the MBMS service, and generating corresponding accounting information based on the time when the UE joins and leaves.

There are two modes of MBMS data transfer between the UTRAN and the UE: the point to multipoint (PTM) transmission mode and point to point (PTP) transmission mode. In the PTM transmission mode, the same data are sent via an MBMS PTM traffic channel (MTCH), and may be received by all UEs having joined the multicast service or interested in the broadcast service. In the PTP transmission mode, the data are sent via a dedicated traffic channel (DTCH), and can be received only by an appropriate UE.

As there may be different numbers of users receiving the MBMS service in one cell, one MBMS service may be provided in one cell in two modes. One is the PTP transmission mode, the other is the PTM transmission mode. As power control can be used in the PTP transmission mode, this mode is used when there are fewer users. If the number of users increases, the PTP transmission mode will consume a lot of radio resources and the transmitting power of the base station may have to become higher. If the PTM transmission mode is used when there are more users, not only the resources of radio interface but also the transmitting power of the base station will be saved. In order to make the radio access network (RAN) obtain the number of users in each cell who demand a particular MBMS service, the MBMS system introduces a counting procedure and a recounting procedure.

The counting procedure refers to the procedure of the RAN counting the number of users who receive a particular MBMS service when an MBMS session starts, while the recounting procedure is introduced because it is necessary to recount the users during the MBMS session so as to determine whether the PTM transmission mode is still the currently suitable bearer mode.

The present invention is aimed primarily at the recounting procedure requested by recounting the number of users during MBMS data transfer.

The steps for MBMS recounting defined in the present protocol are as shown in FIG. 4, which specifically include:

Step 401: a UTRAN transfers MBMS bearer service data to UEs in the PTM transmission mode.

Step 402: when the UTRAN prepares a recounting procedure, it sets the MBMS recounting indication information for the MBMS service and informs the UEs of the MBMS recounting indication information via a common control channel, and at the same time adds the MBMS service identity and access probability factor of the MBMS service to the MBMS access information of the MBMS point-to-multipoint Control Channel (MCCH). It is understood to persons skilled in the art that the reason for using the access probability factor (simplified as probability factor) is that there is no need for all UEs to set up connection to send feedbacks, it is only required that the number of feed-backs reaches a threshold; otherwise, more UEs in the idle mode sending feedbacks may cause uplink block.

Step 403: in the receiving time period of discontinuous reception (DRX), it is necessary for both the UE in the idle mode and connected UE to detect the recounting indication information. If the recounting indication information has been set for this MBMS service, the UE in the idle mode checks the probability factor, and initiates an RRC connection establishing procedure after passing the probability factor check. The probability factor is a random decimal between 0 and 1, the checking procedure of which includes: the UE randomly generates a random decimal between 0 between 1, decides whether the generated random is less than the received probability factor. If the generated random decimal is less than the received probability factor, the check of probability factor will be passed; otherwise it will not be passed.

Meanwhile the connected UE ignores this MBMS access information of the MCCH, as generally speaking, the UTRAN knows at which cell the connected UE are located and does not need the feedback.

Step 404: the UTRAN obtains the information of the UEs interested in the MBMS service from a Core Net (CN) through a UE linking procedure, and carries out counting. The UE linking is a procedure of an Iu interface (the standard interface between a RNC and a CN), which can enable the RNC in the UTRAN to obtain the information of all services which the UEs have joined from the CN.

If the counting result shows that the pre-defined threshold has been reached, the UTRAN will continue using the PTM transmission mode. Otherwise, the UTRAN will repeat the counting procedure with different probability factor values, if the threshold has not been reached during each counting procedure, it is necessary for the UTRAN to change from the PTM transmission mode to the PTP transmission mode.

If the UTRAN still uses the PTM transmission mode, the UTRAN may make the UEs return to the idle mode by an RRC connection releasing procedure.

However, there are the following problems with the above solution: the recounting result during MBMS data transfer is not accurate, which sometimes may cause the UTRAN setting up an unsuitable bearer mode for the cell.

The main reason for this problem is that the purpose of the counting procedure is to determine the number of the UEs which receive a particular MBMS service within a cell. As specified in the present protocol, only the concrete cell locations in the UTRAN of the UEs in the idle mode and the UEs in a state of UTRAN Registration Area Paging Channel (URA-PCH) can not be determined. Therefore, if it is desired to obtain accurate number of the UEs which receive a particular MBMS service, it is necessary to take the number of UEs in these two states into consideration.

According to the present MBMS protocol, only the UEs in the idle mode are taken into consideration when recounting. In fact, as described above, if a UE is in the URA-PCH state, the UTRAN does not know at which specific cell this UE is located. If the UEs in this state are not counted, it is quite likely to make the accuracy of recounting mistaken.

Specifically speaking, in the present protocol, no connected UE responds to the recounting indication as it is generally believed that the UTRAN knows at which cell the connected UEs are located. The present protocol, however, has not taken the URA-PCH state which is somewhat special into consideration. The URA-PCH state is a connected state, but it is only possible to know at which URA the UEs in the URA-PCH state are located rather than which cell they are in. When there is no service, the UEs may switch to the CELL-PCH state and do not receive any signal in normal time, except for receiving signals at the agreed time with the network and reporting the information to the uplink when the located cell changes every time, that has an effect of saving power. The information reported to the uplink will be over frequent if the UEs move rather fast. Therefore, in order to avoid this situation, a UE in the CELL-PCH state will switch to the URA-PCH state if there is no service for a long time. Then the UE will not report the change of cell at which it is located to the network if it is still in the same URA, which may include several cells. In this way, power can be further saved. Therefore, the network does not know the cell at which the UE in the URA-PCH state is located.

Since the switching threshold between the PTM and the PTP is usually rather low, in some cases, even the difference of one or two users may cause the UTRAN establishing an unsuitable bearer mode for a cell so as to make the recounting meaningless and even have a negative impact in some cases. For example, a switch from the PTM to the PTP when a UE is receiving an MBMS service will make the UE unable to receive signals of the MBMS service.

### SUMMARY OF THE INVENTION

In view of the above, the present invention provides a method for recounting the number of the users in the MBMS service so as to make the recounting during MBMS data transfer more accurate and the selection of the MBMS bearer mode by the access network more suitable.

In order to achieve the above object, the technical solution of the present invention is implemented as follows:

a method for recounting in Multimedia Broadcast/Multicast Service (MBMS), when a radio access network (RAN) preparing to initiate a Recounting procedure, includes the following steps:

the RAN sending recounting indication information for an MBMS service to User Equipment (UE) or UEs;

the UE detecting the recounting indication information and responding to the recounting indication information by establishing a radio resource control (RRC) connection or initiating a cell update procedure according to the recounting indication information and received MBMS access information;

the RAN counting the number of the UE(s) which have joined the MBMS service and are within a cell according to the state of the UE(s) respectively.

The step for a RAN sending the recounting indication information includes:

the RAN setting the recounting indication information to comprise an MBMS service identity, adding the MBMS service identity and a first probability factor to the MBMS access information, and sending the recounting indication information and the MBMS access information to the UE(s) via an MBMS point-to-multipoint Control Channel (MCCH), respectively.

The step for the UE detecting the recounting indication information and responding to the recounting indication information further includes:

the UE judging whether it is in an idle mode or in a UTRAN Registration Area Paging Channel (URA-PCH) state; if the UE is in the idle mode or in the URA-PCH state, the UE receiving the MBMS access information, finding the first probability factor of the MBMS service identity which is identical to that in the recounting indication information and checking the first probability factor; the UE in the idle mode or the URA-PCH state that passed the check responding to the recounting indication information by initiating the RRC connection establishment procedure or the cell update procedure respectively.

The method further includes: before sending the recounting indication information, the RAN counting the number of the UE(s) in the UPA-PCH state and deciding whether to use a second probability factor for the UE(s) in the URA-PCH state according to the counting result;

if the second probability factor is decided to be used for the UE(s) in the URA-PCH state, the RAN setting the recounting indication information which comprises the MBMS service identity and indicates that the second probability factor is used therein, adding the MBMS service identity, the first probability factor, and the second probability factor to the MBMS access information and sending the recounting indication information and the MBMS access information to the UE(s) via the MCCH, respectively.

The step for determining whether to use the second probability factor for the UE(s) in the URA-PCH state according to the counting result includes:

the RAN estimating the value of the second probability factor according to the number of the UE(s) in the URA-PCH state, if the number of the UE(s) in the URA-PCH state is small, using a greater second probability factor, otherwise using a less second probability factor; if the estimated second probability factor is close to the first probability factor, choosing the first probability factor instead of the second probability factor; otherwise, choosing the second probability factor.

Whether the number of the UE(s) in the URA-PCH state is small or large is determined by a pre-defined threshold of the number of the UE(s) in the URA-PCH state;

and whether the estimated second probability factor is close to the first access probability factor is determined by a pre-defined range of difference value between the probability factors, if the difference value is within the range, the factors are close; otherwise the factors are not close.

If the RAN decides to use the second probability factor for the UE(s) in the URA-PCH state, the step for the UE detecting the recounting indication information and responding to the recounting indication information includes:

the UE detecting the recounting indication information and judging whether it is in the idle mode or in the URA-PCH state;

upon reception of the MBMS access information, the UE in the idle mode reading the first probability factor of the MBMS service identity which is identical to that in the recounting indication information and checking the first probability factor; the UE in the idle mode that passed the check initiating the RRC connection establishment procedure;

upon reception of the MBMS access information, the UE in the URA-PCH state reading the second probability factor of the MBMS service identity which is identical to that in the recounting indication information and checking the second probability factor; the UE in the URA-PCH state which passed the check initiating the cell update procedure.

The method further includes:

a UE in a cell paging channel (CELL-PCH) state detecting the recounting indication information, receiving the MBMS access information and reading the probability factor of the MBMS service identity which is identical to that in the recounting indication information and checking this probability factor; after passing the check, the UE responding to the recounting indication information by initiating the cell updating procedure;

or a UE in a cell-forward access channel (CELL-FACH) state detecting the recounting indication information, receiving the MBMS access information and reading the probability factor of the MBMS service identity which is identical to that in the recounting indication information and checking the probability factor; after passing the check, the UE responding to the recounting indication information by initiating the cell update procedure or responding via a control channel.

The step for the UE detecting the recounting indication information includes:

the UE monitoring the MCCH and detecting whether there is an MBMS service that has set the recounting indication information upon reception of the recounting indication information from the MCCH, if there is an MBMS service that has set the recounting indication information, the UE having detected the recounting indication information; otherwise, the UE having not detected the recounting indication information.

The step for the RAN counting the number of the UE(s) which have joined the MBMS service and are within a cell according to the state of the UE(s) respectively includes: the RAN counting the UE(s) interested in the MBMS service by combining the UE linking from the CN and the received counting response from the UE.

The RAN counting the number of the UE(s) in the URA-PCH state before sending the recounting indication information, if the number of the UE(s) in the URA-PCH state is small, the RAN indicating that needs not recount the number of the UE(s) in the URA-PCH state through the recounting indication information; the UE(s) in the URA-PCH state not responding to the recounting indication information according to reception of the recounting indication information.

Whether the number of the UE(s) in the URA-PCH state is small or large is determined by defining a threshold of the number of the UE(s) in the URA-PCH state or by pre-defining a threshold of ratio of the UE(s) in the URA-PCH state among all of the UE(s) in the RRC connected state.

The RAN counting the number of the UE(s) in each state of the CELL-FACH and the CELL-PCH before sending the recounting indication information, if the counting result shows that the total number of the UE(s) in those two states reaches the threshold for determining whether to use the point-to-multipoint (PTM) transmission mode, the RAN stopping the recounting procedure, or

querying the UE(s) in those two states whether interested in receiving the MBMS service and performing the recounting procedure again until the threshold used for determining whether to use the PTM transmission mode is reached.

Whether the total number of the UE(s) in those two states added together exceeds the threshold much, which is used for determining whether to use the PTM transmission mode, is determined by setting a threshold of exceeding number.

The RAN makes query of the UE(s) in the two connected states directly via a dedicated or the common channel.

The RAN counting the number of the UE(s) in each connected state of the CELL-FACH and the CELL-PCH before sending the recounting indication information, if the counting result shows that the number of the UE(s) in these two states added together is close to the threshold for determining whether to use the PTM transmission mode, the RAN indicating that needs not recount the number of the UE(s) in the URA-PCH state through the recounting indication information.

The UE in the URA-PCH state not responding to the recounting indication information according to reception of the recounting indication information.

Whether the number of the UE(s) in the two states added together is close to the threshold is determined by a pre-defined range for being close to the threshold, if the number is within the range, it is close to the threshold; otherwise, it is not close to the threshold.

The method further includes:

the UE in the CELL-PCH state, detecting the recounting indication information and responding to the recounting indication information by initiating the cell updating procedure according to the recounting indication information and the received MBMS access information;

or the UE in the CELL-FACH state detecting the recounting indication information and responding to the recounting indication information by initiating the cell update procedure or responding via the control channel according to the recounting indication information and the received MBMS access information.

The method further includes:

the RAN judging whether the counting result has reached the pre-defined threshold for determining whether to use the PTM transmission mode, if the counting result has reached the pre-defined threshold, continuing to use the PTM transmission mode; otherwise deciding whether to use a point-to-point (PTP) transmission mode.

The step for deciding whether to use the PTP transmission mode includes: if the counting result of the number of the UE(s) is less than the pre-defined threshold for determining whether to use the PTM transmission mode, repeating the recounting procedure for pre-defined times, if the results of the repeated recounting for continuous pre-defined times are all less than the threshold for determining whether to use the PTM transmission mode, determining to use the PTP transmission mode.

The method further includes: the RAN determining to use the PTM transmission mode, making the UE(s) return to the idle mode by an RRC connection releasing procedure or making the UE(s) in the URA-PCH state return to the previous state.

In another aspect of the present invention, there is provided a system for recounting in Multimedia Broadcast/Multicast Service (MBMS), comprising a radio access network (RAN) and at least one UE, wherein, the RAN includes:

a first means for sending recounting indication information for an MBMS service to the at least one UE;

a second means for counting the number of the UE(s) which have joined the MBMS service and are within a cell according to the state of the respective one of the UE(s);

the at least one UE who need to be recounted detecting the recounting indication information and responding to the recounting indication information by establishing a radio resource control (RRC) connection or initiating a cell update procedure according to the recounting indication information and received MBMS access information.

In still yet another aspect of the present invention, there is provided a ratio access network (RAN) for recounting in Multimedia Broadcast/Multicast Service (MBMS), including: a first means for sending recounting indication information for an MBMS service to a User Equipment (UE) or UEs;

a second means for counting the number of the UE(s) which have joined the MBMS service according to the state of the UE respectively;

a third means for judging whether the number of UE passes a pre-defined threshold, if so, continuing to use PTM transmission mode, otherwise, switching transmission mode from PTM transmission mode to PTP transmission mode.

It can be seen from the above solution that the method, system and apparatus for recounting the number of the UEs in an MBMS in accordance with the present invention not only make the UEs in the idle mode recounted, but also make the UEs in the URA-PCH state recounted according to the needs so that the number obtained by recounting is more accurate, the selection made between the PTM and PTP transmission mode is more appropriate, and the UEs needing to receive the service when the PTM transmission mode is switched to the PTP transmission mode are guaranteed to be able to receive the service signals.

In addition, an access probability factor for the URA-PCH state may be used in the present invention so that the counting result of the UEs in the idle mode and URA-PCH state could be more reliable.

Furthermore, the present invention makes it possible to recount the number of the UEs according to the numbers of UEs in the CELL-FACH and CELL-PCH states so that decisions based on counting results of higher accuracy could be made in many cases with less system resources consumed.

### BRIEF DESCRIPTION OF THE DRAWINGS

FIG. 1 shows system architecture of an MBMS defined by the 3GPP;

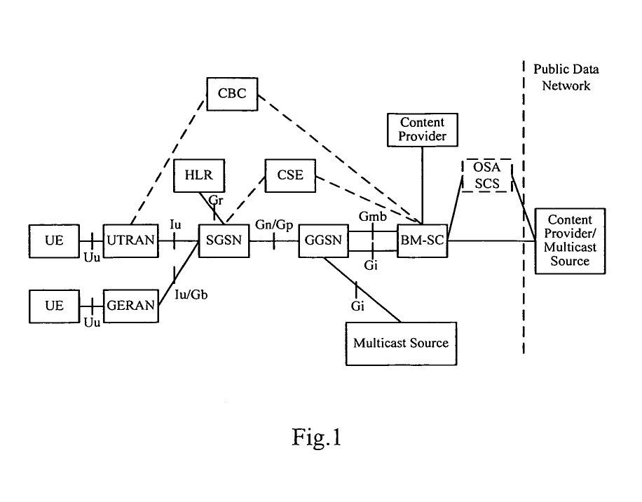

FIG. 2 shows a flowchart for an MBMS in the multicast mode;

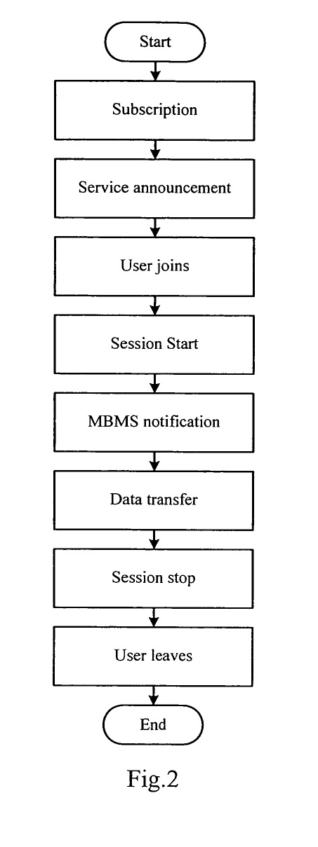

FIG. 3 shows a flowchart for an MBMS in the broadcast mode;

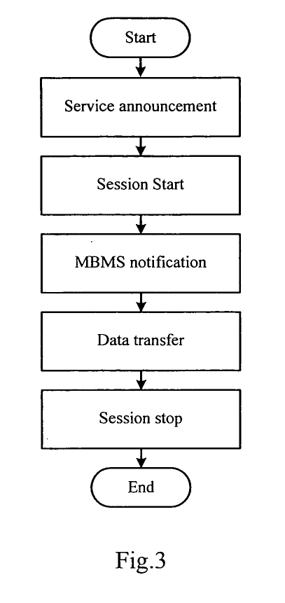

FIG. 4 shows a flowchart for recounting in an MBMS according to the present protocol;

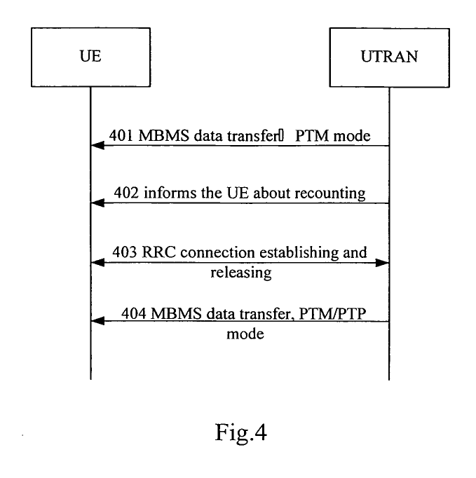

FIG. 5 shows a flowchart for recounting during MBMS data transfer in a first preferred embodiment in accordance with the present invention;

FIG. 6 shows a flowchart for recounting during MBMS data transfer in a second preferred embodiment in accordance with the present invention.

### EMBODIMENTS OF THE INVENTION

The present invention is hereinafter described in detail with reference to the accompanying drawings and exemplary embodiments so that the object, solution, and merits thereof could be more apparent.

The idea of the present invention makes it possible to recount not only the number of the UEs in the idle mode but also the number of the UEs in the URA-PCH state according to the recounting indication information.

In the present invention, the network side indicates whether to recount only the number of the UEs in the idle mode or to recount the number of the UEs in both idle mode and the URA-PCH state through the recounting indication information. The UEs in the idle mode and the UEs in the URA-PCH state respond to the recounting indication information according to the indication.

In the present invention, the network either provides an access probability factor for the use of the UEs in the URA-PCH state or just uses the access probability factor for the use of the UEs in the idle mode. Whether to provide this factor for the use of the UEs in the URA-PCH state can be decided by the network based on the number of the UEs in the URA-PCH state in the particular URA. Or the network just separately sets the factor for the UEs in the URA-PCH state. It is a matter of how to implement the method.

The present invention can be implemented in various ways. Hereinafter six preferred embodiments are described in detail.

First preferred embodiment:

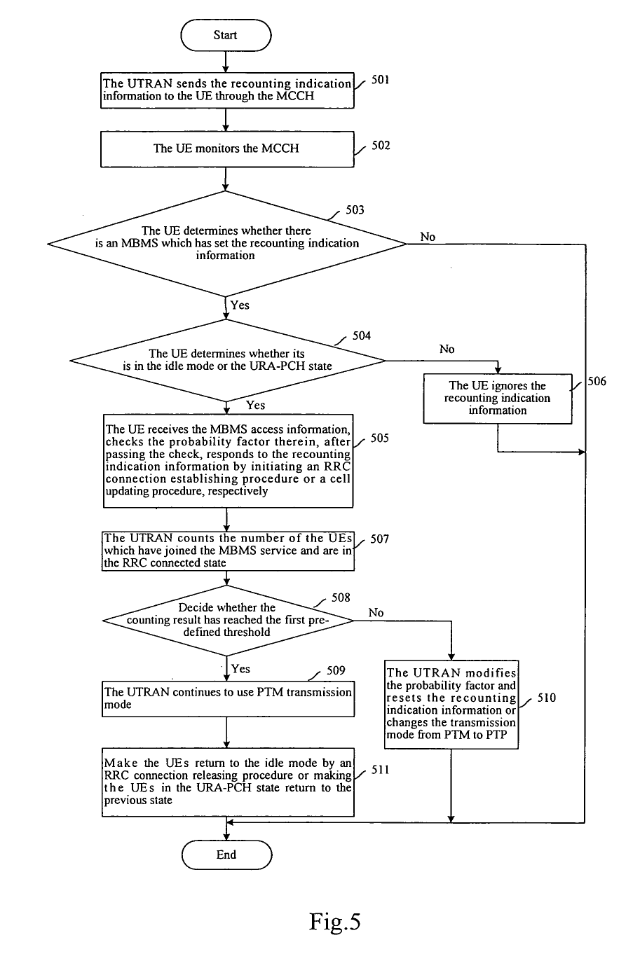

Referring to FIG. 5, which is a flowchart for recounting during MBMS data transfer in accordance with the first preferred embodiment of the present invention. The specific procedure includes following steps:

Step 501: when preparing to initiate a recounting procedure, the UTRAN sets the recounting indication information that includes an MBMS service identity, meanwhile, adds the MBMS service identity and an access probability factor to MBMS access information, and notifies UEs of the recounting indication information and the MBMS access information via an MCCH, respectively.

The notifying method of this embodiment is known by a person skilled in the art, and a detailed description is omitted here.

Step 502: the UE monitors the MCCH. After the UE receives the recounting indication information, go to Step 503.

Step 503: the UE detects whether an MBMS service has set the recounting indication information. If an MBMS service has set the recounting indication information, go to Step 504; otherwise, terminate the counting procedure.

Step 504: the UE detects whether it is in the idle mode or in the URA-PCH state. If it is in the idle mode or in the URA-PCH state, go to Step 505; otherwise, go to Step 506.

Step 505: the UE receives the MBMS access information, finds the probability factor of which MBMS service identity is identical to that in the recounting indication information, and checks the probability factor. If the UE passes the probability check, the UE initiates an RRC connection establishing procedure or a cell updating procedure for responding to recounting response, and goes to Step 507; if the UE does not pass the probability check, the UE terminates the counting procedure.

In this step, the process of checking the probability factor is similar known by the person skilled in the art, and a detailed description is omitted here.

Step 506: the UE not in the URA-PCH state but in other RRC connected states ignores the recounting indication information and terminates the counting procedure.

The UE in the idle mode responds to the recounting indication by performing an RRC connection procedure and the UE in the URA-PCH state responds to the recounting indication by performing a cell updating procedure. Of course, the UEs in the CELL-FACH and the CELL-PCH states in this embodiment can also respond to the recounting indication. Therefore, all related UEs can be recounted together, thereby improving the recounting accuracy.

Step 507: the UTRAN counts the number of the UEs which are in the RRC connected state and have joined the MBMS service.

In this step, the UTRAN obtains the information about whether the UEs in the RRC connected state have joined the MBMS service from the CN through the UE linking procedure, and counts the number of the UEs which are in the connection state and have joined the MBMS service.

Step 508: the UTRAN decides whether the counting result has reached the pre-defined first threshold for determining whether to use the PTM transmission mode. If the counting result has reached the pre-defined first threshold, go to Step 509; otherwise, go to Step 510.

Step 509: the UTRAN goes on to use the PTM transmission mode. Go to Step 511.

Step 510: the UTRAN modifies the probability factor and resets the recounting indication information, or changes the transmission mode from the PTM to the PTP. Terminate this procedure.

In this embodiment, if the recounting result does not reach the first predefined threshold before recounting has been repeated for the pre-defined times in this step, the probability factor can be increased and the recounting can be repeated; if the result of recounting has continuously failed to reach the first predefined threshold for the pre-defined times in this step, the UTRAN changes the transmission mode from the PTM to the PTP.

Step 511: the UEs return to the idle mode through the RRC connection releasing procedure, or the UEs currently in the URA-PCH state return to the previous state. Terminate this procedure.

It can be noted that, the counted UEs may be kept in the RRC connected state as well.

Second preferred embodiment:

In this embodiment, the network side decides whether to use the second probability factor for the UEs in the URA-PCH state according to the number of the UEs in the URA-PCH state, and the UEs in the URA-PCH state decide whether to use the first probability factor generally used or use the second probability factor according to the recounting indication information. In this embodiment, it is supposed that the UEs in the idle mode use the first probability factor generally used while the UEs in the URA-PCH state use the second probability factor.

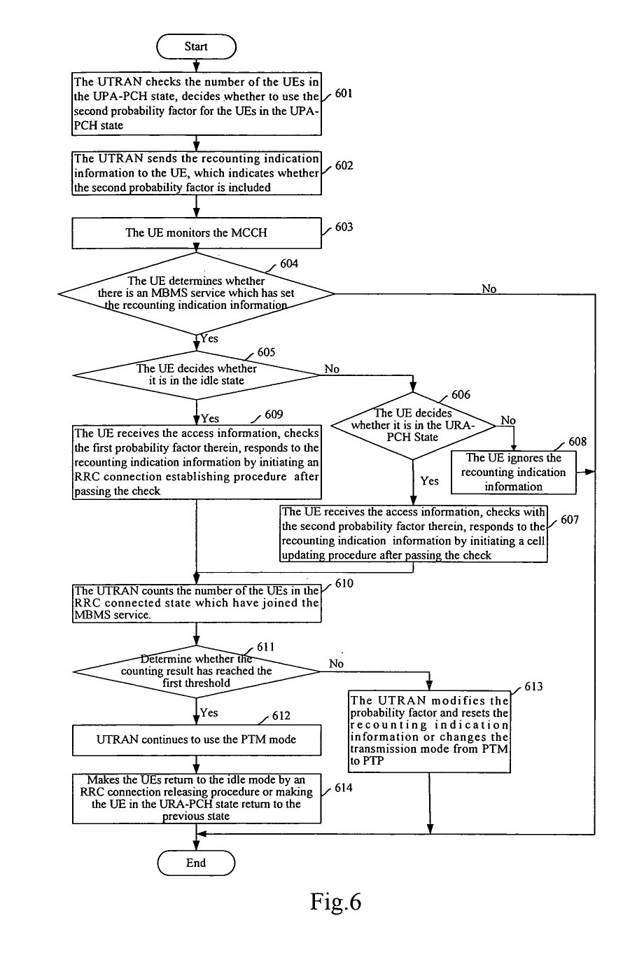

Referring to FIG. 6, a flowchart for recounting during MBMS data transfer of the second embodiment in accordance with the present invention, the procedure includes the steps of:

Step 601: a UTRAN checks the number of the UEs in the URA-PCH state, and decides whether to use a second probability factor for the UEs in the URA-PCH state.

If it is decided to use the second probability factor, go to Step 602; otherwise, perform the procedure as shown in FIG. 5.

In this step, the UTRAN may predefine a threshold of the number of the UEs in the URA-PCH state; if the number of the UEs in the URA-PCH state has reached or exceeded the threshold, it is decided to use the second probability factor. In this embodiment, it is supposed that the second probability factor is used.

When counting the number of the UEs in the URA-PCH state, whether it is needed to use the second probability factor, estimation of how large a probability factor is desirable can be made based on the number of the UEs in the URA-PCH state firstly. The method of estimation is that a larger probability factor can be used when the number of the UEs in the URA-PCH state is small, whereas a smaller probability factor is used when the number of the UEs is great. If the estimated probability factor is close to the access probability factor generally used for the UEs in the idle mode, it is decided that the first probability factor is used and the second probability factor is not needed; otherwise it is decided that the second access probability factor is needed. Whether the estimated probability factor is close to the first probability factor generally used for the UE in the idle mode can be decided by pre-defining a difference range of probability factor, if the difference is within the range, the two factors are close; otherwise, they are not close.

Step 602: the UTRAN transfers recounting indication information to the UEs via an MCCH, and includes a second probability factor in the MBMS access information.

Specifically speaking, the UTRAN sets the recounting indication information that includes an MBMS service identity, meanwhile, adds the MBMS service identity, the first probability factor and the second probability factor to the MBMS access information, and notifies the UEs of the recounting indication information and the MBMS access information via the MCCH, respectively.

Step 603: the UE monitors the MCCH, and goes to Step 604 after receiving the indication information.

Step 604: the UE detects whether an MBMS service has set recounting indication information. If an MBMS service has set recounting indication information, go to Step 605; otherwise, terminate the counting procedure.

Step 605: the UE decides whether it is in the idle mode. If it is in the idle mode, go to Step 609; otherwise, go to Step 606.

Step 606: the UE decides whether it is in the URA-PCH state. If it is in the URA-PCH state, go to Step 607; otherwise, go to Step 608.

Step 607: the UE receives the MBMS access information, uses the second provability factor thereof to carry on a probability check and responds to the recounting indication information after passing the check by initiating a cell updating procedure. If the UE fails in passing the check, terminate the counting procedure.

Step 608: the UE in the CELL-PCH state receives the MBMS access information, uses the first provability factor thereof to carry on a probability check and responds to the recounting indication information after passing the check by initiating a cell updating procedure; or the UE in the CELL-FACH state receives the MBMS access information, uses the first provability factor thereof to carry on a probability check, and responds to the recounting indication information after passing the check by initiating a cell updating procedure or responds to the recounting indication information via the control channel.

However, special probability factors may be set for the UE in these two states respectively, or one probability factor is used for the UE in different states.

Step 609: the UE receives the MBMS access information, uses the first probability factor thereof to carry on a probability check and responds to the recounting indication information after passing the check by initiating an RRC connection establishing procedure. If the UE fails in passing the check, terminate the counting procedure.

Step 610: the UTRAN counts the number of the UEs which are in the RRC connected state and have joined this MBMS service.

This step is completely the same as Step 507 which is as shown in FIG. 5, so no description will be repeated here.

Step 611: the UTRAN decides whether the counting result has reached the pre-defined first threshold. If the counting result has reached the pre-defined first threshold, go to Step 612; otherwise go to Step 613.

Step 612: the UTRAN continues to use the PTM transmission mode. Go to Step 614.

Step 613: the UTRAN modifies the probability factor and resets the recounting indication information, or changes the transmission mode from the PTM to the PTP.

In the embodiment, if the recounting result does not reach the first pre-defined threshold before recounting has been implemented for the pre-defined times in this step, the probability factor can be increased and the recounting can be repeated. If in this step, the recounting result has continuously failed in reaching the first pre-defined threshold for the pre-defined times, the UTRAN will change the transmission mode from the PTM to the PTP.

Step 614: the UE returns to the idle mode through an RRC connection releasing procedure, or the UE currently in the URA-PCH state returns to the previous state. Terminate this procedure.

In this embodiment, the UE first decides whether it is in the idle mode, and then decides whether it is in the URA-PCH state. Of course, this order of making decision has no effect on the result and can be set at will.

Third preferred embodiment:

In this embodiment, a step for deciding is added based on the first preferred embodiment, i.e. when preparing to initiate a recounting procedure, the UTRAN decides how many UEs are in the URA-PCH state, if the number of the UEs is very small, these UEs will not be counted. Whether the number of the UEs in the URA-PCH is small or large can be determined by setting a threshold of the number of the UEs in the URA-PCH state, or by setting a threshold of the ratio of the UEs in the URA-PCH state among all UEs in the RRC connected state, for example, if the UEs in the URA-PCH state are less than 5% of all of the UEs in the RRC connected state, it will be considered that the number of the UEs in the URA-PCH state is small.

Concretely speaking, when notifying the UEs, the network side indicates through the recounting indication information that no recounting is to be carried out for the UEs in the URA-PCH state. The UEs in the URA-PCH state, do not respond to this recounting indication information according to the indication after receiving this indication.

The advantage of doing so is that the step for the few UEs currently in the URA-PCH state returning to the previous state can be omitted when the UTRAN still uses the PTM transmission mode so that unnecessary resource occupation could be reduced.

Fourth preferred embodiment:

This embodiment is an improvement of the first preferred embodiment. In this embodiment, when preparing to initiate a recounting procedure, the UTRAN first counts the number of the UEs in both the CELL-FACH and the CELL-PCH states, if the counting result shows that the number of the UEs in the two states added together is much larger than the threshold, no recounting will be carried out, i.e. this procedure is terminated. For example, when the total number of the UEs in the two states exceeds a pre-defined threshold of the exceeding number, no recounting will be carried out.

It is believed that a certain ratio of the UEs in the connected state would receive the MBMS service, and when the total number of the UEs in the two states is large, a sufficient number of UEs are believed to receive the service. Therefore, this approach avoids unnecessary occupation of system resources in the recounting procedure.

Fifth preferred embodiment:

This embodiment improves the fourth preferred embodiment. In this embodiment, when preparing to initiate a recounting procedure, the UTRAN will also count the number of the UEs in both the CELL-FACH and the CELL-PCH states. If the counting result shows that the number of the UEs in the two states added together is much larger than the threshold, the UEs in these two states are first inquired about whether they receive this MBMS service, then recounting is carried out if the counting result of the number of the UEs which receive the MBMS service is less than the threshold. The UTRAN may inquire the UEs in these two states directly via a dedicated or a common channel.

In addition, in this embodiment, the UTRAN may also adopt the approach described in the above second preferred embodiment, i.e. indicating that recounting is to be made for the UEs in the CELL-FACH and the CELL-PCH states through the recounting indication information. The UEs in the CELL-FACH and the CELL-PCH states are then counted according to the recounting indication information. This procedure is the same as Step 608 in FIG. 6, and is not repeated herein.

Sixth preferred embodiment:

This embodiment also improves the fourth preferred embodiment. As in the fourth embodiment, the number of the UEs in both the CELL-FACH and the CELL-PCH states is counted firstly, if the counting result shows that the number of the UEs in these two states added together is already close to the threshold, then the network side indicates through the recounting indication information not to recount the number of the UEs in the URA-PCH state. After receiving this indication, the UEs in the URA-PCH state do not respond to this indication of recounting according to the indication.

Whether the number of the UEs in the two states added together is already close to the threshold is determined by pre-defining a range for being close to the threshold. If the number is within the range, it is close to the threshold, otherwise it is not close.

As the number of the UEs in the two connected states is already large, it is quite likely that the number of the UEs in the idle mode and the UEs in these two connected states has exceeded the threshold by querying, that is, the enquiry on the UEs in the URA-PCH state is omitted. The advantage of doing so is to omit the step of the UEs currently in the URA-PCH state returning to the previous state such that unnecessary occupation of resources could be avoided.

It can be seen from the above embodiments that the prominent feature of the present invention is that the UEs in the URA-PCH state also respond to the recounting indication. In the prior art, the UEs in the URA-PCH state which seldom occur to the mind of persons skilled in the art are ignored. However, in the procedure of MBMS recounting, as the selection of a bearer mode is sensitive to the counting result, a larger number of the UEs in the URA-PCH state may play a key role. Therefore, recounting in accordance with the present invention presents a more accurate counting result than in the prior art and the selection of an MBMS bearer mode by the UTRAN based on this counting result is more appropriate.

Though the present invention has been described with reference to the drawings and some preferred embodiments, it should be appreciated by people skilled in the art that various changes in form and details may be made on the invention without deviating from the spirit and scope of the present invention as specified by the attached claims.

1. A method for recounting in Multimedia Broadcast/Multicast Service (MBMS), when a radio access network (RAN) preparing to initiate a Recounting procedure, comprising the following steps:
the RAN sending recounting indication information for an MBMS service to User Equipment (UE) or Ues;
the UE detecting the recounting indication information and responding to the recounting indication information by establishing a radio resource control (RRC) connection or initiating a cell update procedure according to the recounting indication information and received MBMS access information;
the RAN counting the number of UE(s) which have joined the MBMS service and are within a cell according to the state of the UE(s) respectively.

2. The method according to claim 1, wherein the step for a RAN sending the recounting indication information comprises:
the RAN setting the recounting indication information to comprise the MBMS service identity, adding the MBMS service identity and a first probability factor to the MBMS access information, and sending the recounting indication information and the MBMS access information to the UE(s) via an MBMS point-to-multipoint Control Channel (MCCH) respectively.

3. The method according to claim 2, wherein the step for the UE detecting the recounting indication information and responding to the recounting indication information further comprises:
the UE judging whether it is in idle mode or in a UTRAN Registration Area Paging Channel (URA-PCH) state; if the UE is in the idle mode or in the URA-PCH state, the UE receiving the MBMS access information, finding the first probability factor of the MBMS service identity which is identical to that in the recounting indication information and checking the first probability factor; the UE in the idle mode or the URA-PCH state that passed the check responding to the recounting indication information by initiating the RRC connection establishment procedure or the cell update procedure respectively.

4. The method according to claims 3, further comprising:
a UE in a cell paging channel (CELL-PCH) state detecting the recounting indication information, receiving the MBMS access information, and reading the probability factor of the MBMS service identity which is identical to that in the recounting indication information and checking this probability factor; after passing the check, the UE responding to the recounting indication information by initiating the cell updating procedure;
or a UE in a cell-forward access channel (CELL-FACH) state detecting the recounting indication information, receiving the MBMS access information, and reading the probability factor of the MBMS service identity which is identical to that in the recounting indication information and checking the probability factor; after passing the check, the UE responding to the recounting indication information by initiating the cell update procedure or responding via control channel.

5. The method according to claim 2, further comprising: before sending the indication information, the RAN counting the number of UE(s) in the UPA-PCH state and deciding whether to use a second probability factor for the UE(s) in the URA-PCH state according to the counting result;
if the second probability factor is decided to be used for the UE(s) in the URA-PCH state, the RAN setting the recounting indication information which comprises the MBMS service identity and indicates that the second probability factor is used therein, adding the MBMS service identity, the first probability factor, and the second probability factor to the MBMS access information, and sending the recounting indication information and the MBMS access information to the UE(s) via the MCCH respectively.

6. The method according to claims 5, further comprising:
the UE in the cell paging channel (CELL-PCH) state detecting the recounting indication information, receiving the MBMS access information, and reading the probability factor of the MBMS service identity which is identical to that in the recounting indication information and checking this probability factor; after passing the check, the UE responding to the recounting indication information by initiating the cell updating procedure;
or the UE in the cell-forward access channel (CELL-FACH) state detecting the recounting indication information, receiving the MBMS access information, and reading the probability factor of the MBMS service identity which is identical to that in the recounting indication information and checking the probability factor; after passing the check, the UE responding to the recounting indication information by initiating the cell update procedure or responding via control channel.

7. The method according to claim 5, wherein the step for determining whether to use the second probability factor for the UE(s) in the URA-PCH state according to the counting result comprises:
the RAN estimating the value of the second probability factor according to the number of the UE(s) in the URA-PCH state, if the number of the UE(s) in the URA-PCH state is small, using a greater second probability factor, otherwise using a less second probability factor; if the estimated second probability factor is close to the first probability factor, choosing the first probability factor instead of the second probability factor; otherwise, choosing the second probability factor.

8. The method according to claim 7, wherein whether the number of UE(s) in the URA-PCH state is small or large is determined by a pre-defined threshold of the number of UE(s) in the URA-PCH state;
and whether the estimated second probability factor is close to the first access probability factor is determined by a pre-defined range of difference between the probability factors, if the difference is within the range, the factors are close, otherwise the factors are not close.

9. The method according to claim 5, if the RAN decides to use the second probability factor for the UE(s) in the URA-PCH state, wherein the step for the UE detecting the recounting indication information and responding to the recounting indication information comprises:
the UE detecting the recounting indication information and judging whether it is in the idle mode or in the URA-PCH state;
upon reception of the MBMS access information, the UE in the idle mode reading the first probability factor of the MBMS service identity which is identical to that in the recounting indication information and checking the first probability factor; the UE in the idle mode that passed the check initiating the RRC connection establishment procedure;
upon reception of the MBMS access information, the UE in the URA-PCH state reading the second probability factor of the MBMS service identity which is identical to that in the recounting indication information and checking the second probability factor; the UE in the URA-PCH state which passed the check initiating the cell update procedure.

10. The method according to claim 1, wherein the step for the UE detecting the recounting indication information comprises:
the UE monitoring the MCCH and detecting whether there is an MBMS service that has set the recounting indication information upon reception of the recounting indication information from the MCCH, if there is an MBMS service that has set the recounting indication information, the UE having detected the recounting indication information; otherwise the UE having not detected the recounting indication information.

11. The method according to claim 1, wherein the step for the RAN counting the number of the UE(s) which have joined the MBMS service and are within a cell according to the state of the UE(s) respectively comprises: the RAN counting the UE(s) interested in the MBMS service by combining the UE linking from the CN and the received counting response from the UE.

12. The method according to claim 1, further comprising: the RAN counting the number of the UE(s) in the URA-PCH state before sending the recounting indication information, if the number of the UE(s) in the URA-PCH state is small, the RAN indicating that needs not recount the number of the UE(s) in the URA-PCH state through the recounting indication information; in the step for the UE detecting the recounting indication information and responding to the recounting indication information, the UE(s) in the URA-PCH state not responding to the recounting indication information according to reception of the recounting indication information.

13. The method according to claim 12, wherein whether the number of UE(s) in the URA-PCH state is small or large is determined by defining a threshold of number of UE(s) in the URA-PCH state or by pre-defining a threshold of ratio of UE(s) in the URA-PCH state among all the UE(s) in the RRC connected state.

14. The method according to claim 1, further comprising: the RAN counting the number of UE(s) in each state of the CELL-FACH and the CELL-PCH before sending the recounting indication information; if the counting result shows that the total number of the UE(s) in those two states reaches the threshold for determining whether to use the point-to-multipoint (PTM) transmission mode, the RAN stopping the recounting procedure, or
querying UE(s) in these two states whether the UE(s) are interested in receiving and performing the recounting procedure again until the threshold used for determining whether to use the PTM transmission mode is reached.

15. The method according to claims 14, wherein whether the total number of the UE(s) in those two states added together considerably exceeds the threshold much which is used for determining whether to use the PTM transmission mode is determined by setting a threshold of exceeding number.

16. The method according to claim 14, wherein the RAN makes query of the UE(s) in the two connected states directly via a dedicated or common channel.

17. The method according to claim 1, further comprising: the RAN counting the number of the UE(s) in the two connected states of CELL-FACH and CELL-PCH before sending the; if the counting result shows that the number of the UE(s) in those two states added together is close to the threshold used for determining whether to use the PTM transmission mode, the RAN indicating that needs not recount the number of UE(s) in the URA-PCH state through the not to recount;
in the step for the UE detecting the recounting indication information and responding to the recounting indication information, the UE in the URA-PCH state not responding to the recounting indication information according to the reception of the recounting indication information.

18. The method according to claim 17, wherein whether the number of UE(s) in the two states added together is close to the threshold is determined by a pre-defined range for being close to the threshold, if the number is within the range, it is close to the threshold, otherwise it is not close to the threshold.

19. The method according to claim 18, further comprising:
the UE in the CELL-PCH state, detecting the recounting indication information and responding to the recounting indication information by initiating the cell updating procedure according to the recounting indication information and the received MBMS access information;
or the UE in the CELL-FACH state detecting the recounting indication information and responding to the recounting indication information by initiating the cell update procedure or responding via the control channel according to the recounting indication information and the received MBMS access information.

20. The method according to claim 1, further comprising:
the RAN judging whether the counting result has reached the pre-defined threshold for determining whether to use the PTM transmission mode, if the counting result has reached the pre-defined threshold, continuing to use the PTM transmission mode, otherwise deciding whether to use a point-to-point (PTP) transmission mode.

21. The method according to claim 20, wherein the step for deciding whether to use the PTP transmission mode comprises: if the counting result of the number of UE(s) is less than the pre-defined threshold for determining whether to use the PTM transmission mode, repeating the recounting procedure for pre-defined times, if the results of repeated recounting for continuous pre-defined times are all less than the threshold for determining whether to use the PTM transmission mode, determining to use the PTP transmission mode.

22. The method according to claim 20, further comprising: the RAN determining to use the PTM transmission mode, making the UE(s) return to the idle mode by an RRC connection releasing procedure or making the UE(s) in the URA-PCH state return to the previous state.

23. A system for recounting in Multimedia Broadcast/Multicast Service (MBMS), comprising a radio access network (RAN) and at least one UE, wherein the RAN comprises:
a first means for sending recounting indication information for an MBMS service to the at least one UE;
a second means for counting the number of the UE(s) which have joined the MBMS service and are within a cell according to the state of the respective one of the UE(s);
the at least one UE who need to be recounted adapted to detect the recounting indication information and respond to the recounting indication information by establishing a radio resource control (RRC) connection or initiating a cell update procedure according to the recounting indication information and received MBMS access information.

24. A radio access network (RAN) for recounting in Multimedia Broadcast/Multicast Service (MBMS) comprising:
a first means for sending recounting indication information for an MBMS service to a User Equipment (UE) or UEs;
a second means for counting the number of the UE(s) which have joined the MBMS service according to the state of the UE respectively;
a third means for judging whether the number of UE passes a pre-defined threshold, if so, continuing to use PTM transmission mode, otherwise, switching transmission mode from PTM transmission mode to PTP transmission mode.
